(19) United States
(12) Patent Application Publication
(10) Pub. No.: US 2014/0020008 A1
(43) Pub. Date: Jan. 16, 2014

(54) INFORMATION PROCESSING DEVICE AND METHOD FOR SETTING VOICE COMMUNICATION FUNCTION

(71) Applicant: KABUSHIKI KAISHA TOSHIBA, Tokyo (JP)

(72) Inventor: Fujihito Numano, Tokyo (JP)

(73) Assignee: Kabushiki Kaisha Toshiba, Tokyo (JP)

(21) Appl. No.: 13/778,547

(22) Filed: Feb. 27, 2013

(30) Foreign Application Priority Data
Jul. 11, 2012 (JP) 2012-155420

(51) Int. Cl. H04N 21/61

(52) U.S. Cl. CPC H04N 21/6125
USPC 725/25; 725/106

(57) ABSTRACT

According to one embodiment, an information processing device includes a connection module, determination module, and a setting module. The connection module is configured to connect to Internet. The determination module is configured to determine a start-up trigger for the information processing device based on a start-up instruction to the information processing device. The setting module is configured to switch a state for a voice communication function via the Internet based on the start-up trigger and to set the switched state.

### CROSS-REFERENCE TO RELATED APPLICATIONS

This application is based upon and claims the benefit of priority from Japanese Patent Application No. 2012-155420, filed Jul. 11, 2012, the entire contents of which are incorporated herein by reference.

### FIELD

Embodiments described herein relate generally to an information processing device which enables voice communication and a method for setting a voice communication function.

### BACKGROUND

The spread of Internet networks has enabled television receiving devices to acquire contents via the Internet networks.

Furthermore, an IP phone using IP (Internet Protocol) has been made available on a television receiving device.

When started up, the television receiving device may initiate, for example, an IP phone function (IP phone application) and sign in to the IP phone function with a particular user's account set in the television receiving device. Moreover, the television receiving device may set the status of the user of the IP phone function who has signed in to an incoming call standby state.

However, the start-up of the television receiving device may be triggered not only by a power-on input by a particular user but also by a power-on input by any user other than the particular user. The start-up of the television receiving device may also be triggered by a preset timer function such as a programmed recording function, an on timer function, or a reminder function.

When the television receiving device signs in to the IP phone function regardless of the trigger for starting up the television receiving device to set the status of the user to the incoming call standby status, the set status is not always correct.

If the status is not correctly set, the user inconveniently needs to take the trouble of switching to the correct status for the IP phone function. On the other hand, a calling user checks a called user's status before making an IP phone call. If the status of the called user is incorrect, the called user will not initiate a conversation, and the calling user is forced to spend a useless wait time.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram illustrating an example of a television receiving device according to an embodiment.

FIG. 2 is an exemplary flowchart illustrating an example of a process of initiating an IP phone function according to the embodiment.

FIG. 3 is an exemplary flowchart illustrating another example of the process of initiating the IP phone function according to the embodiment.

FIG. 4 is an exemplary flowchart of a sign-in process for the IP phone function according to the embodiment.

FIG. 5 is an exemplary flowchart of a sign-out process for the IP phone function according to the embodiment.

FIG. 6 is an exemplary flowchart of a process of changing timeout according to the embodiment.

FIG. 7 is an exemplary diagram of a screen for an example according to the embodiment.

FIG. 8 is an exemplary diagram of a screen for an example of the IP phone function according to the embodiment.

FIG. 9 is an exemplary diagram of a screen for an example of the IP phone function according to the embodiment.

### DETAILED DESCRIPTION

Various embodiments will be described hereinafter with reference to the accompanying drawings.

In general, according to one embodiment, an information processing device includes a connection module, a determination module, and a setting module. The connection module is configured to connect to Internet. The determination module is configured to determine a start-up trigger for the information processing device based on a start-up instruction to the information processing device. The setting module is configured to switch a state for a voice communication function via the Internet based on the start-up trigger and to set the switched state.

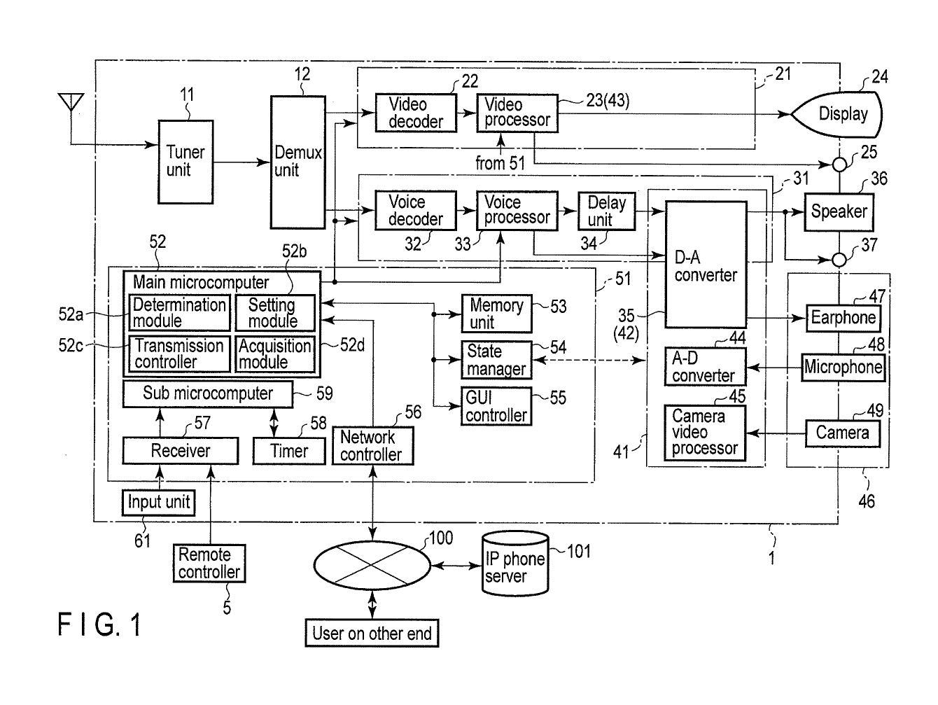

FIG. 1 is a block diagram illustrating an example of a television receiving device (information processing device) 1 according to the present embodiment. The television receiving device 1 receives, for example, broadcast waves or contents transmitted via an Internet network 100 to reproduce videos. Moreover, the television receiving device 1 makes an IP phone function using IP (a voice (sound, audio) communication function provided via the Internet network 100) available between a user of the television receiving device 1 and a user of an IP phone connected to the television receiving device 1 via the Internet network 100. The IP phones enable not only voice-only communication but also voice communication with video. An IP phone server 101 which controls IP phones is connected to the IP phone network 100. The present embodiment will be described taking the television receiving device 1 as an example. However, the present embodiment is applicable to any device that can be connected to the Internet network 100 and that enables the IP phone function to be initiated.

The television receiving device 1 comprises a tuner unit 11, a Demux unit (demultiplexer) 12, a video processing block 21, a voice processing block 31, a display 24, a speaker 36, an IP phone controller 41, a main control block 51, and an input unit 61.

The tuner unit 11 receives content data via broadcast waves and supplies the content data to the Demux unit 12. The Demux unit 12 separates the content data into video data and voice data. The Demux unit 12 supplies the video data to the video processing block 21, while supplying the voice data to the voice processing block 31.

The video processing block 21 comprises a video decoder 22 and a video processor 23. The video decoder 22 decodes the video data and supplies the decoded video data to the video processor 23. The video processor 23 converts the video data into data with a predetermined resolution and in a predetermined output format, for example, an interlaced (i) format or a non-interlaced (p) format so that the succeeding display 24 can display the vide data. The video processor 23 then supplies the resultant video data to the display 24. The video processor 23 may supply the video data to an output end 25 to which for example, an external monitor can be connected.

The voice processing block 31 comprises a voice decoder 32, a voice processor 33, a delay unit 34, a D (Digital)-A (Analog) converter 35. The voice decoder 32 decodes voice data and supplies the decoded voice data to the voice processor 33. The voice processor 33 processes the voice data so that the succeeding speaker 36 can reproduce the voice data. The voice processor 33 then supplies the resultant voice data to the delay unit 34. The delay unit 34 applies a predetermined time delay to the voice data in order to temporally match the voice data output by the voice processor 33 with the video data output by the video processor 23. The delay unit 34 supplies the resultant voice data to the D-A converter 35. The D-A converter 35 converts the voice data into analog voice and supplies the voice to the speaker 36. The D-A converter 35 may supply the voices to an output end 37 to which for example, an external speaker can be connected.

The IP phone controller 41 comprises a D-A converter 42, a video processor 43, an A-D converter 44, and a camera video processor 45. The IP phone controller 41 can be connected to a communication set 46 including earphone (voice reproducer) 47, a microphone (voice input unit) 48, and a camera (image taking unit) 49. The communication set 46 may be an element included in the television receiving device 1 or another element. The IP phone controller 41 controls voice communication or voice communication with video with a user on the other end via the Internet network 100, according to an IP phone function which operates in accordance with firmware in the main control block 51 or a prepared application (program), for example, “Skype”, IP telephony provided by Skype Inc.

The D-A converter 42 is supplied, by the voice processor 33 or the delay unit 34, with voice data transmitted via the Internet network 100, described below, by the user on the other end using an IP phone. The D-A converter 42 converts the video data into analog voice and supplies the analog voice to the earphone 47. The D-A converter 42 may be an element which is the same as or different from the above-described D-A converter 35. The video processor 43 processes video data transmitted by the user on the other end so that the succeeding display 24 can display the video data. The video processor 43 can reproduce still images represented by for example, JPEG (Joint Photographic Experts Group) images and moving pictures represented by for example, MPEG (Moving Picture Experts group)-2, -4 (H.264-AVC) images. The video processor 43 may be an element which is the same as or different from the above-described video processor 23.

The A-D converter 44 converts a voice input through the microphone 48 into digital voice data. The A-D converter 44 supplies the voice data to the main control block 51 in order to allow voice data to be transmitted to the user on the other end by IP phone.

The camera video processor 45 processes video data from the camera 48, which takes an image of the face of the user who is within the image taking coverage of the camera 48 (for example, in front of the display 24). The camera video processor 45 supplies the video data to the main control block 51 in order to allow the video data to be transmitted to the transmitted to the user on the other end by IP phone. The camera video processor 45 also has a function to detect and authenticate the face of the user who is within the image taking coverage of the camera 48 (the present embodiment is not limited to the user's face but any biological information may be used) based on the video data from the camera 48. A technique for face detection and authentication is not particularly limited. The face detection and authentication function may be provided in the camera 48. In this case, the camera video processor 45 may receive the result of the face authentication from the camera 48.

The main control block 51 comprises a main microcomputer 52, a memory unit 53, a state manager 54, a GUI (Graphical User Interface) controller 55, a network controller 56, a receiver 57, a timer 58, and a sub microcomputer 59.

The main microcomputer 52 controls the operation of each element of the television receiving device 1. The main microcomputer 52 comprises a determination module 52a, a setting module 52b, a transmission controller 52c, and an acquisition module 52d. The determination module 52a determines, for example, a trigger for starting up the television receiving device 1 as described below. The setting module 52b carries out various settings for the IP communication function as described below. The transmission controller 52c, for example, controllably transmits various types of information to the IP phone server 101 as described below. The acquisition module 52d acquires the user's account recorded in the memory unit 53 as described below. The memory unit 53 includes at least a ROM which holds operation programs, a RAM which functions as a work memory, and a memory which stores various types of information. The state manager 54 manages incoming calls transmitted to the IP phone controller 41 via the Internet network 100 or transmissions from the IP phone controller 41 to the user on the other end. The GUI controller 55 displays a GUI on the display 24 and processes user inputs provided through the GUI. The network controller 56 controls a connection to the Internet network 100. The network controller 56 functions as a connection module connected to the Internet network 100.

The receiver 57 receives instructions provided via an input unit 61 or the remote controller 5. For example, the input unit 61 or the remote controller 5 enables inputting of the user's instruction to immediately start up (power on) the television receiving device 1. The receiver 57 supplies the sub microcomputer 59 with the instruction to start up the television receiving device 1. According to the present embodiment, the start-up instruction provided to the sub microcomputer 59 via the receiver 57 is hereinafter referred to as a start-up instruction based on (provided by) the user's operation.

The timer 58 functions as an RTC (Real Time Clock) which clocks the current date and time and which manages a date and time preset by the user using a timer function such as a programmed recording function, an on timer function, or a reminder function. When the current date and time coincides with the set date time, the timer 58 supplies the sub microcomputer 59 with the instruction to start up the television receiving device 1. According to the present embodiment, the start-up instruction provided to the sub microcomputer 59 by the timer 58 is hereinafter referred to as a start-up instruction based on the RTC or a start-up instruction based on the preset timer function.

Even while the television receiving device 1 is powered off, the sub microcomputer 59 is operative and waits to receive the instruction to start up the television receiving device 1 from the receiver 58 or the timer 59. That is, the sub microcomputer 59 manages the trigger for starting up the television receiving device 1 based on the start-up instruction. The sub microcomputer 59 records the trigger for starting up the television receiving device 1 in a register 691.

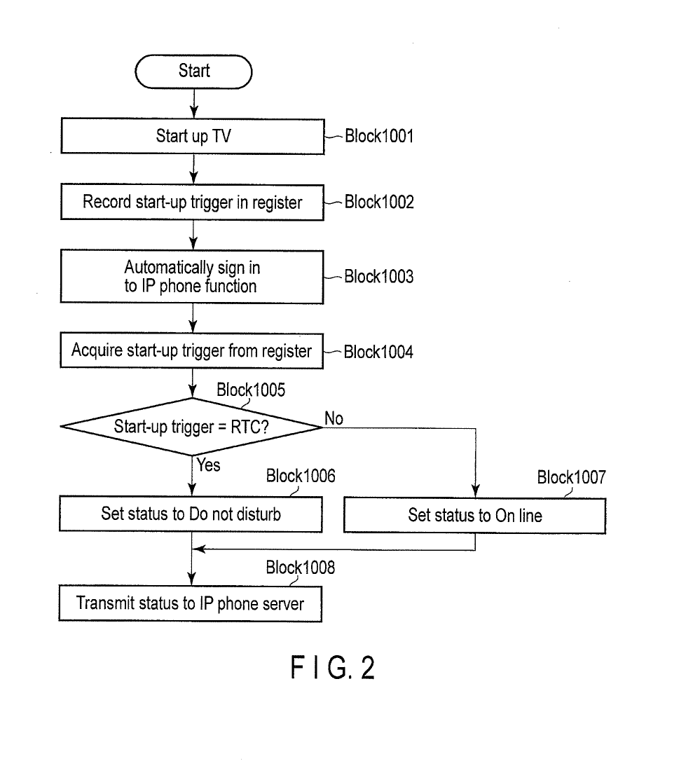

Now, a process of initiating the IP phone function will be described. FIG. 2 is a flowchart of an example of the process of initiating the IP phone function when the television receiving device 1 is started up. The television receiving device 1 is assumed to be powered off.

The sub microcomputer 59 detects the instruction to start up the television receiving device 1 (Block1001). In Block1001, the main microcomputer 52 controllably starts up the television receiving device 1 based on the detection of the start-up instruction by the sub microcomputer 59. Based on the received start-up instruction, the sub microcomputer 59 records the trigger for starting up the television receiving device 1 in a register 591 (Block1002). The main microcomputer 52 initiates the IP phone function and automatically signs in to the IP phone function with a particular account set in the television receiving device 1 (Block1003). The sign-in is an input for enabling the IP phone function to be carried out with a particular account name and has the same meaning as that of login. The main microcomputer 52 acquires the start-up trigger from the register 591 (Block1004). The main microcomputer 52 determines whether or not the start-up trigger is based on the RTC (preset timer function) (Block1005). That is, in Block1005, the main microcomputer 52 determines the trigger for starting up the television receiving device 1 based on the instruction to start up the television receiving device 1. If the start-up trigger is based on the RTC (that is, if the start-up instruction is issued by a timer function) (Block 1005, Yes), the main microcomputer 52 sets a status for the IP phone function (incoming call standby method) to “Do not disturb” (Block1006). The status indicates the current state of the user with the account with which the user has signed in. The status is set automatically or by the user's operation. According to the present embodiment, the “Do not Disturb” status indicates that for example, if an incoming call is received from the user on the other end by IP phone, the user with the signed-in account cannot reply to the incoming call or stand by for the incoming call, that is, the user cannot immediately start a conversation. If the start-up trigger is not based on the RTC (that is, the start-up trigger is based on the start-up instruction based on (provided by) the user's operation (that is, the start-up instruction issued by a user)) (Block1005, No), the main microcomputer 52 sets the status for the IP phone function to “On line” (Block1007). According to the present embodiment, the “On line” status indicates that for example, if an incoming call is received from the user on the other end by IP phone, the user with the account with which the user has signed in can reply to the incoming call or has been standing by for the incoming call, that is, the user can immediately start a conversation. The main microcomputer 52 controllably transmits information about the status for the IP phone function set in Block1006 or Block1007, to the IP phone server 101 (Block 1008).

The processing shown in FIG. 2 allows the main microcomputer 52 to appropriately automatically switch the state of the IP phone function either to the “On line” status or to the “Do not Disturb” status based on the start-up trigger. Thus, the user can omit an operation of setting the status.

The user on the other end can receive status information about other users distributed by the IP telephone server 101 and display the status information on an execution screen for the IP phone function. Similarly, the main microcomputer 52 can controllably receive, via the network controller 56, status information about other users distributed by the IP telephone server 101 and display the status information on an execution screen for the IP phone function.

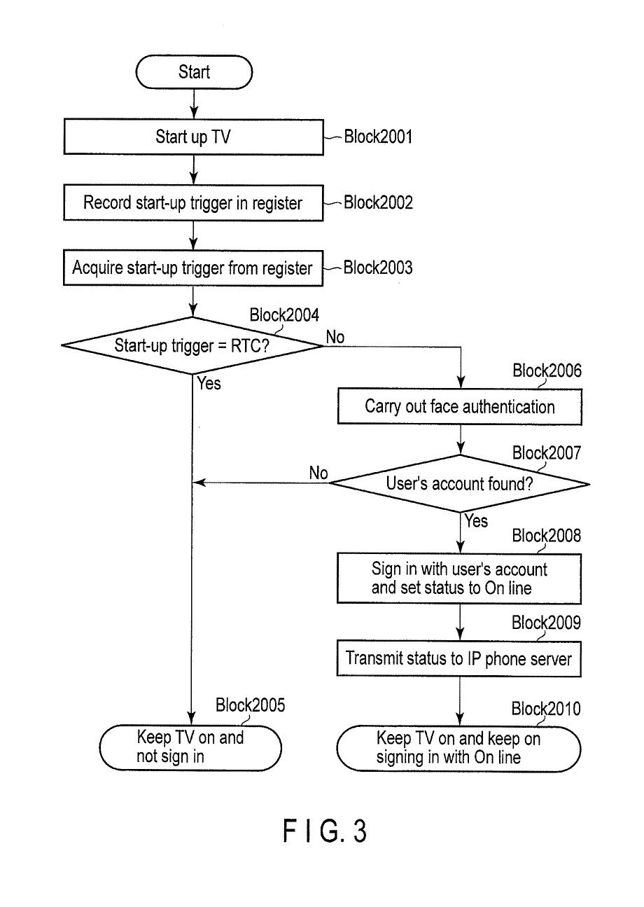

FIG. 3 is a flowchart of another example of the process of starting up the IP phone function when the television receiving device 1 is started up. The television receiving device 1 assumed to be powered off.

The sub microcomputer 59 detects the instruction to start up the television receiving device 1 (Block2001). In Block2001, the main microcomputer 52 controllably starts up the television receiving device 1 based on the detection of the start-up instruction by the sub microcomputer 59. Based on the received start-up instruction, the sub microcomputer 59 records the trigger for starting up the television receiving device 1 in the register 591 (Block2002). The main microcomputer 52 acquires the start-up trigger from the register 591 (Block2003). The main microcomputer 52 determines whether or not the start-up trigger is based on the RTC (preset timer function) (Block2004). That is, in Block2004, the main microcomputer 52 determines the trigger for starting up the television receiving device 1 based on the instruction to start up the television receiving device 1. If the start-up trigger is based on the RTC (Block2004, Yes), the main microcomputer 52 keeps the television receiving device 1 on but controllably prevents a sign-in to the IP phone function. If the start-up trigger is not based on the RTC (that is, if the start-up trigger is based on (provided by) the user's operation) (Block2004, No), the camera video processor 45 carries out face authentication (biological authentication) (Block2006). In Block2006, the camera video processor 45 carries out face detection and face authentication based on the control of the main microcomputer 52. The camera video processor 45 then transmits the result of the face authentication to the main microcomputer 52. The face detection and the face authentication may be carried out by the main microcomputer 52.

Based on the result of the face authentication of the user who is within the image talking coverage of the camera 48, the main microcomputer 52 determines whether or not the account corresponding to the user subjected to the face authentication is recorded in the memory unit 53 (Block 2007). If the account is not recorded in the memory unit 53 (if the main microcomputer 52 cannot acquire the account) (Block2007, No), the main microcomputer 52 carries out the processing in Block2005. If the account is recorded in the memory unit 53 (Block2007, Yes), the main microcomputer 52 acquires the account and initiates the IP phone function. The main microcomputer 52 then signs in to the IP phone function with the acquired account, and sets the status for the IP phone function to “On line” (Block2008). The main microcomputer 52 controllably transmits information about the set status for the IP phone function to the IP phone server 101 via the network controller 56 (Block2009). The main microcomputer 52 keeps the television receiving device 1 on and also allows the television receiving device 1 to keep on signing in to the IP phone function with the “On line” status (Block2010).

The processing shown in FIG. 3 allows the main microcomputer 52 to appropriately automatically switch the status of the IP phone function either to no sign-in or to the “On line” status based on the start-up trigger and the face authentication. Thus, the user can omit the operation of setting the status.

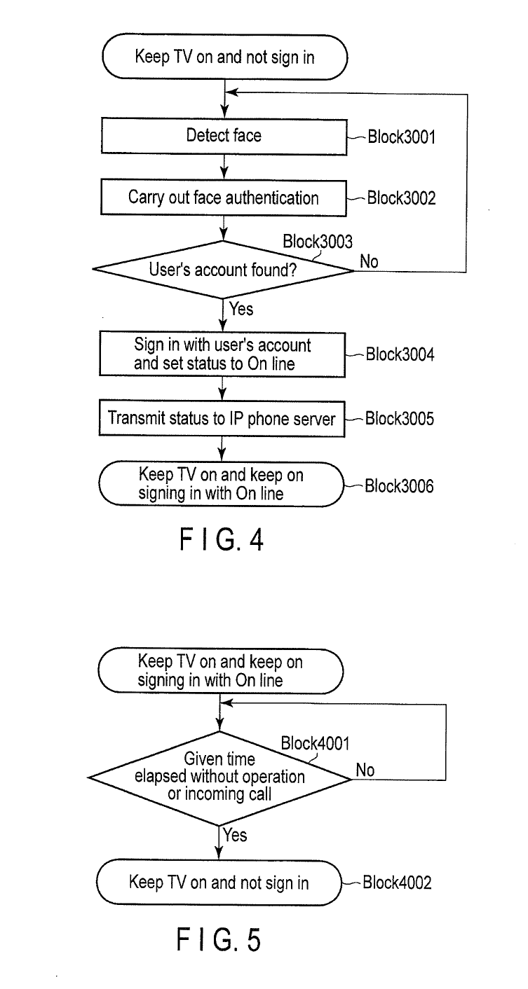

Now, processing carried out by the television receiving device 1 after Block2005 will be described. FIG. 4 is a flowchart of a sign-in process for the IP phone function. Here, the television receiving device 1 is assumed to remain powered on and to keep on avoiding signing in to the IP phone function.

The camera video processor 45 acquires face data obtained by the camera 48 to carry out face detection (Block3001). The camera video processor 45 carries out face authentication (Block3002). The processing in Block3002 may be similar to the processing in Block2006. Based on the result of the face authentication, the main microcomputer 52 determines whether or not the account corresponding to the user subjected to the face authentication is recorded in the memory unit 53 (Block3003).

If the account is not recorded in the memory unit 53 (Block3003, No), the main microcomputer 52 returns to Block3001 to wait for the camera video processor 45 to carry out the face detection process. If the account is recorded in the memory unit 53 (Block3003, Yes), the main microcomputer 52 acquires the account and initiates the IP phone function. The main microcomputer 52 then signs in to the IP phone function with the acquired account, and sets the status for the IP phone function to “On line” (Block3004).

The main microcomputer 52 controllably transmits information about the set status for the IP phone function to the IP phone server 101 via the network controller 56 (Block3005). The main microcomputer 52 keeps the television receiving device 1 on and also allows the television receiving device 1 to keep on signing in to the IP phone function with the “On line” status (Block3006).

The processing shown in FIG. 4 allows a state setting process (the sign-in process and the process of setting the status) to be appropriately automatically carried out based on face authentication. Thus, the user can omit the sign-in process and the process of setting the status.

Now, processing carried out by the television receiving device 1 after Block2010 will be described. FIG. 5 is a flowchart of a sign-out process for the IP phone function. Here, the television receiving device 1 is assumed to remain powered on and to keep on signing in to the IP phone function with the “On line” status.

The main microcomputer 52 determines whether or not a given time has elapsed without the user's operation for the IP phone function or an incoming call from the user on the other end (Block4001). If the given time has not elapsed (Block4001, No), the main microcomputer 52 continues waiting for the user's operation or an incoming call from the user on the other end.

If the given time has elapsed (Block4001, Yes), the main microcomputer 52 controllably keeps the television receiving device 1 on but allows the television receiving device 1 to sign out from the IP phone function, that is, allows the television receiving device 1 to keep on avoiding signing in to the IP phone function (Block4002). That is, in Block4002, the main microcomputer 52 stops the operation of the IP phone function. The main microcomputer 52 may change the status for the IP phone function to “Do not Disturb” to set the “Do not Disturb” status instead of signing out from the IP phone function.

The processing shown in FIG. 5 allows the user to notify the user on the other end of the correct status if for example, the user has been away from the television receiving device 1 for a given time.

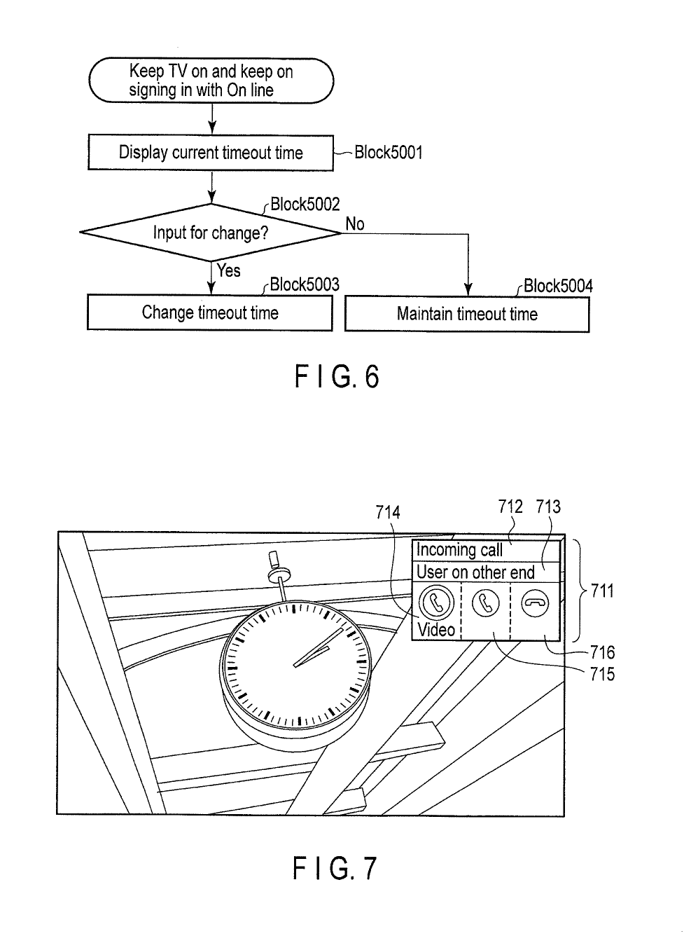

FIG. 6 is a flowchart of a process of changing the given time (hereinafter referred to as a timeout time) in Block4001. The example shown in FIG. 6 corresponds to the process of changing the timeout time at a predetermined timing using an adjusting UI (User Interface). The main microcomputer 52 controllably allows the current timeout time to be shown on the display 24 at a predetermined timing (Block5001). The predetermined timing is at least one of a timing after the status for the IP phone function is set to “On line” in Block1007, a moment when (after) the television receiving device 1 signs in to the IP phone function in Block2008, a moment when the user spontaneously signs out from the IP phone function, and the like. However, the predetermined timing is not limited. The spontaneous sign-out includes a sign-out based on (provided by) the user's operation for using the input unit 61 or the remote controller 5 to manually (spontaneously) sign out from the IP phone function.

The main microcomputer 52 controllably allows a screen for a change in current timeout time to be shown on the display 24, and determines whether or not a change has been input by the user's operation (Block5002). The screen for a change in timeout time displays, for example, a check box for times (for example, “−5 minutes”, “−10 minutes”, “+5 minutes”, and “+10 minutes”) to be added to the current timeout time. If a change has been input (Block5002, Yes), the main microcomputer 52 changes the timeout time and controllably records the changed timeout time in the memory unit 53 (Block 5003). The main microcomputer 52 uses the changed timeout time to carry out the processing in the flowchart shown in FIG. 5. If no change has been input (Block5002, No), the main microcomputer 52 maintains the timeout time without any change (Block5004).

The processing shown in FIG. 6 allows the user to set the optimum timeout time according to the user's lifestyle. For example, if the timeout time is excessively long, the user needs to spontaneously sig out from the IP phone function. When signing out, the user can increase a sensitivity for the automatic sign-out by optimally setting the timeout time.

FIG. 7 is a diagram of a screen for an example of the IP phone function shown on the display 24 after the television receiving device 1 signs in to the IP phone function. If an incoming IP phone call is received via the Internet network 100 while the display 24 is showing contents, the GUI controller 55 controllably allows an “incoming call display” 711 to be shown so as to be superimposed on the contents. The “incoming call display” 711 is shown, for example, in the upper right of the screen. The “incoming call display” 711 includes, for example, an “incoming call display” 712 showing that an incoming call has arrived, a “user on the other end display” 713 showing a sender, that is, the user on the other end, and a “reply display <1>” 714, a “reply display <2>” 715, and a “reply display <3>” 716 showing a method for replying. The “reply display <1>” 714 shows an audio with video reply to the incoming call. The “reply display <2>” 715 shows audio-only reply to the incoming call. The “reply display <3>” 716 shows that no reply is to be made. The user can select one of the methods for replying by for example, using the remote controller 5 to move a cursor or to carry out focusing.

If the status for the IP phone function is set to the “On line”, the main microcomputer 52 controllably allows an incoming call sound to be output through the speaker 36 when the state manager 54 detects the incoming call. Moreover, the main microcomputer 52 controllably allows the GUI controller 55 to show, on the display 24, a standby screen with the “incoming call display” 711 shown in FIG. 7. Thus, the main microcomputer 52 maintains the setting for the incoming call standby state until the user inputs a reply instruction in response to the incoming call.

On the other hand, if the status for the IP phone function is set to “Do not Disturb” (if the user is predicted not to be near the television receiving device 1, the main microcomputer 52 immediately initiates an answering machine function (recording function) when the state manager 54 detects the incoming call. The main microcomputer 52 avoids outputting the incoming call sound from the speaker 36 but controllably inhibits the GUI controller 55 from showing a standby screen such as the “incoming call display” 711 shown in FIG. 7. That is, the main microcomputer 52 sets the incoming call standby to be disabled.

The present embodiment can save the user the trouble of setting the initiation of the answering machine function. Thus, the user on the other end is immediately connected to the answering machine function, eliminating a useless wait time.

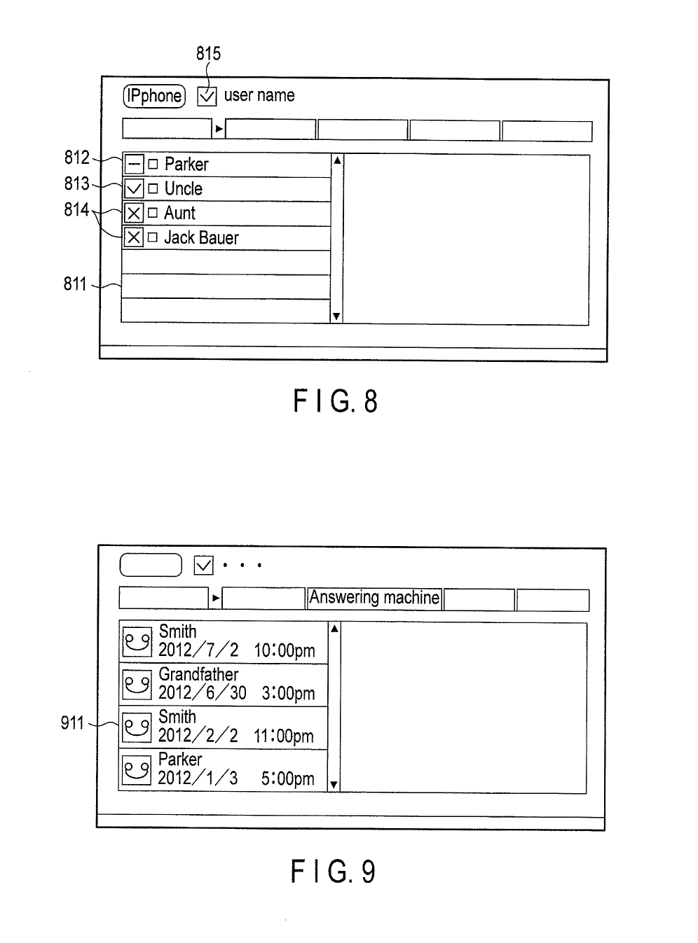

FIG. 8 is a diagram of a screen for another example of the IP phone function shown on the display 24 after the television receiving device 1 signs in to the IP phone function. The IP phone function screen displays a telephone directory (a list of users on the other end) 811. The telephone directory 811 displays the names of the users on the other end in association with the current status. As described above, the current status is based on information distributed by the IP phone server 101. The status is displayed as corresponding marks such as a “Do not Disturb” mark 812, an “On line” mark 813, and an “Invisible” mark 814. The “Invisible” mark indicates that the television receiving device 1 has not signed in. These types of status are illustrative and the present embodiment is not limited to these types. The IP phone function screen also displays the status 815 of the user corresponding to the account with which the television receiving device 1 has signed in.

FIG. 9 is a diagram of a screen for an example of the IP phone function shown in the display 24 after the television receiving device 1 signs in to the IP phone function. The IP phone function screen displays a list 911 of information about the answering machine. The IP phone function screen may display a list for voice mails recorded by the IP phone server 101 instead of by the television receiving device 1.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
a connection module configured to connect to Internet;
a determination module configured to determine a start-up trigger for the information processing device based on a start-up instruction to the information processing device; and
a setting module configured to switch a state for a voice communication function via the Internet based on the start-up trigger and to set the switched state.

2. The device of claim 1, wherein if the start-up trigger is based on a preset timer function, the setting module is configured to initiate the voice communication function and set the state for the voice communication function to an incoming call standby disabled state.

3. The device of claim 2, wherein the setting module is configured to initiate a recording function if an incoming call is received.

4. The device of claim 1, wherein if the start-up trigger is based on the start-up instruction provided by a user's operation, the setting module is configured to initiate the voice communication function and set a state for the voice communication function to an incoming call standby state.

5. The device of claim 1, further comprising a transmission controller configured to transmit information about the state for the voice communication function to a server.

6. The device of claim 1, wherein if the start-up trigger is based on a timer function, the setting module is controllably configured to prevent the information processing device from signing in to the voice communication function.

7. The device of claim 1, further comprising an acquisition module configured to acquire an account corresponding to a user based on biological authentication of the user who is within an image taking coverage of a camera connected to the information processing device,
wherein the setting module is configured to sign in to the voice communication function with the account and set a state for the voice communication function to an incoming call standby state.

8. The device of claim 7, wherein if the acquisition module fails to acquire the account, the setting module is controllably configured to prevent the information processing device from signing in to the voice communication function.

9. The device of claim 8, wherein while the information processing device does not signed in to the voice communication function, the acquisition module is configured to acquire the account based on the biological authentication, and
the setting module is configured to sign in to the voice communication function with the account and set a state for the voice communication function to the incoming call standby state.

10. The device of claim 1, wherein if a given time has elapsed without a user's operation or an incoming call after sign-in to the voice communication function, the setting module is configured to stop an operation of the voice communication function.

11. The device of claim 10, wherein after the information processing device signs in to the voice communication function and when the information processing device signs out from the voice communication function, the setting module is controllably configured to display a screen for a change in the given time to change the given time based on a user's operation.

12. A method for setting a voice communication function, the method comprising:
determining a start-up trigger for a device based on a start-up instruction to the device; and
switching a state for a voice communication function via Internet based on the start-up trigger and to set the switched state.
